(19) United States
(12) Patent Application Publication
(10) Pub. No.: US 2025/0309439 A1
(43) Pub. Date: Oct. 2, 2025

(54) MANUFACTURING METHOD OF BATTERY MODULE

(71) Applicant: HONDA MOTOR CO., LTD., Tokyo (JP)

(72) Inventors: Hirokazu WATANABE, Saitama (JP); Yosuke YOSHIZAWA, Saitama (JP); Hidemasa USUI, Saitama (JP)

(21) Appl. No.: 19/064,638

(22) Filed: Feb. 26, 2025

(30) Foreign Application Priority Data
Mar. 29, 2024 (JP) 2024-057691

(51) Int. Cl. H01M 50/242; H01M 50/204; H01M 50/291

(52) U.S. Cl. CPC H01M 50/242; H01M 50/204; H01M 50/291

(57) ABSTRACT

There is provided a manufacturing method of a battery module, the battery module including a battery cell stack including a stack of a plurality of battery cells, a pair of plate-shaped members provided at both ends of the battery cell stack in a stacking direction, and a cushion material arranged between the plurality of battery cells and/or between the battery cell stack and the plate-shaped members, the cushion material including a first elastic member having a frame-shaped member arranged on an outer circumferential portion, a second elastic member arranged inside the first elastic member, and a third elastic member arranged on both sides of the battery cell stack in the stacking direction of the battery cell stack, the second elastic member having wave-shaped plate springs stacked in the stacking direction of the battery cell stack, the manufacturing method including.

This application is based on and claims the benefit of priority from Japanese Patent Application No. 2024-057691, filed on 29 Mar. 2024, the content of which is incorporated herein by reference.

### BACKGROUND OF THE INVENTION

### Field of the Invention

The present invention relates to a manufacturing method of a battery module.

### Related Art

In recent years, research and development concerning secondary batteries that contribute to energy efficiency has been conducted to enable more people to access affordable, reliable, sustainable, and advanced energy.

Since battery cells expand and contract during charging and discharging, battery modules include, for example, a pair of end plates provided at both ends of a battery cell stack in a stacking direction, and a bind bar that binds the battery cell stack between the pair of end plates.

Japanese Unexamined Patent Application, Publication No. 2022-156427 discloses a power storage device including a power storage module that includes a plurality of power storage cells stacked in the stacking direction, a housing case that houses the power storage module, and restriction units arranged between the power storage cells. Here, each of the restriction units includes a first plate and a second plate spaced in the stacking direction, and a wave plate arranged between the first plate and the second plate.
Patent Document 1: Japanese Unexamined Patent Application, Publication No. 2022-156427

### SUMMARY OF THE INVENTION

However, when the restriction units in the power storage device disclosed in Japanese Unexamined Patent Application, Publication No. 2022-156427 are compressed due to expansion of the power storage cells at the time of charging, a large difference in surface pressure occurs between a portion of the first plate and the second plate that are in contact with the wave plate and a portion of the first plate and the second plate that are not in contact with the wave plate, which reduces the uniformity in surface pressure of the restriction units. In addition, in the power storage device disclosed in Japanese Unexamined Patent Application, Publication No. 2022-156427, positional deviation tends to occur when the wave plate is arranged between the first plate and the second plate, and therefore the restriction units are not easily assembled.

It is an advantage of the present invention to provide a manufacturing method of a battery module capable of enhancing uniformity in surface pressure of a cushion material and the ease of assembling.
(1) A manufacturing method of a battery module, the battery module including a battery cell stack including a stack of a plurality of battery cells, a pair of plate-shaped members provided at both ends of the battery cell stack in a stacking direction, and a cushion material arranged between the plurality of battery cells and/or between the battery cell stack and the plate-shaped members, the cushion material including a first elastic member having a frame-shaped member arranged on an outer circumferential portion, a second elastic member arranged inside the first elastic member, and a third elastic member arranged on both sides of the battery cell stack in the stacking direction of the battery cell stack, the second elastic member having wave-shaped plate springs stacked in the stacking direction of the battery cell stack, the manufacturing method including: a step of forming the second elastic member by stacking the wave-shaped plate springs inside the first elastic member; and a step of forming the third elastic member by foaming and molding resin inside the first elastic member where the second elastic member is formed, in which when the third elastic member is formed, longitudinal end portions of the second elastic member are in contact with the frame-shaped member.
(2) The manufacturing method of a battery module according to the aspect (1), in which the second elastic member is formed so that a plurality of contact regions where the second elastic member is in contact with a bottom surface of the first elastic member are present in a width direction, the wave-shaped plate spring that is in contact through the contact regions has an extension portion extending outward in the width direction from the contact region present in an outermost portion in the width direction, and as the extension portion increases in distance in the width direction from the contact region that is present on the outermost portion in the width direction, a distance in a thickness direction from the bottom surface of the first elastic member increases.
(3) The manufacturing method of a battery module according to the aspect (1) or (2), in which the bottom surface of the first elastic member has a wave-shaped cross section that corresponds to a wave-shaped cross section of the plate spring that is in contact with the bottom surface of the first elastic member.
(4) The manufacturing method of a battery module according to any one of the aspects (1) to (3), in which the frame-shaped member has a groove-shaped portion in a region facing an end portion of the second elastic member in the width direction.
(5) The manufacturing method of a battery module according to the aspect (4), in which the groove-shaped portion has both side surfaces that are shaped so as to correspond to the end portion of the second elastic member in the width direction.
(6) The manufacturing method of a battery module according to any one of the aspects (1) to (5), in which the battery cells are solid-state battery cells.

The present invention can provide the manufacturing method of a battery module capable of enhancing uniformity in surface pressure of a cushion material and the ease of assembling.

### BRIEF DESCRIPTION OF THE DRAWINGS

FIG. 1 is a sectional view showing a battery module according to an embodiment of the present invention;

FIG. 2 is a sectional view showing a cushion material in FIG. 1;

FIG. 3 is a sectional view showing a manufacturing method of the cushion material shown in FIG. 2;

FIG. 4 is a partially enlarged sectional view of a first elastic member and a second elastic member in FIG. 3;

FIG. 5 is a sectional view showing a wave-shaped plate spring in FIG. 3;

FIG. 6 is a sectional view showing a modification of the first elastic member in FIG. 3;

FIG. 7 is a partially enlarged sectional view showing the modification of the first elastic member in FIG. 3; and

FIG. 8 is a partially enlarged sectional view showing the modification of the first elastic member in FIG. 7.

### DETAILED DESCRIPTION OF THE INVENTION

Hereinafter, an embodiment of the present invention will be described with reference to the drawings.

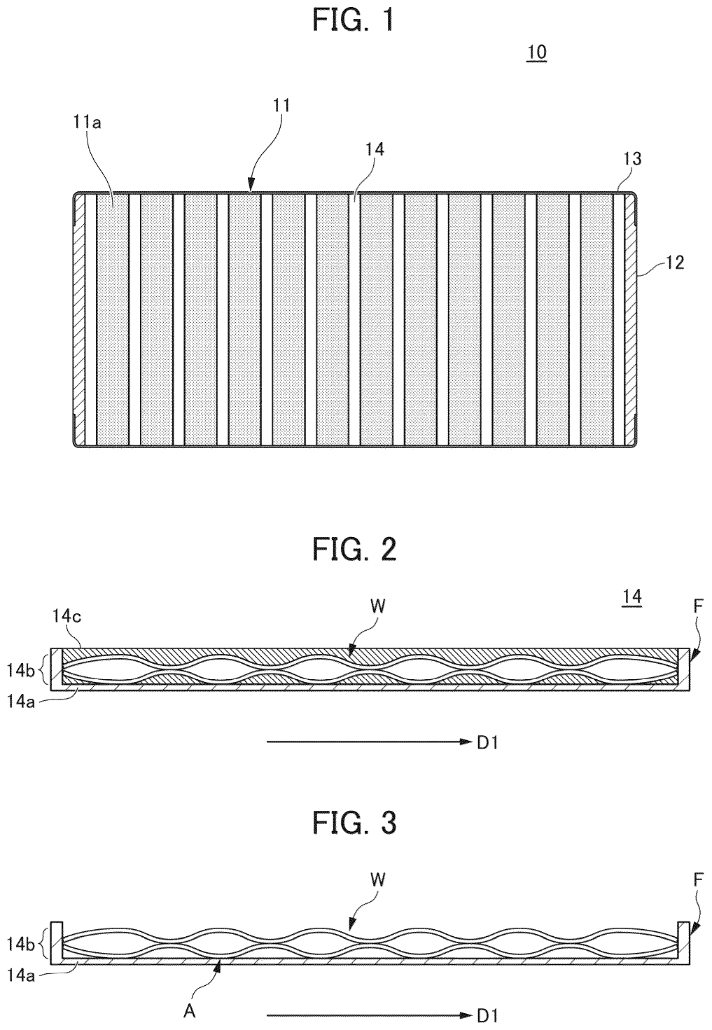

FIG. 1 shows a battery module according to an embodiment of the present invention.

### [Battery Module]

A battery module 10 includes a battery cell stack 11 formed by stacking a plurality of battery cells 11a, end plates 12 as a pair of plate-shaped members provided on both ends of the battery cell stack 11 in a stacking direction, and a bind bar 13 as a restraining member that restrains the battery cell stack 11 between the pair of end plates 12. Here, the bind bar 13 is installed at two locations that are an upper location and a lower location in the drawing.

The battery module 10 has a cushion material 14 arranged between the plurality of battery cells 11a and between the battery cell stack 11 and the end plates 12.

The cushion material 14 may be arranged between the plurality of battery cells 11a or between the battery cell stack 11 and the end plates 12.

As shown in FIG. 2, the cushion material 14 includes a first elastic member 14a having a frame-shaped member F arranged on an outer circumferential portion, a second elastic member 14b arranged inside the first elastic member 14a, and a third elastic member 14c arranged on both sides of the second elastic member 14b in the stacking direction of the battery cell stack 11. The second elastic member 14b has two wave-shaped plate springs W stacked in the stacking direction of the battery cell stack 11. This reduces hysteresis loss of the cushion material 14.

Here, when the cushion material 14 is compressed due to expansion of the battery cells 11a at the time of charging, the uniformity in surface pressure is improved since the third elastic member 14c (and 14a) is interposed between the battery cell 11a and the second elastic member 14b.

The first elastic member 14a has the frame-shaped member F arranged on the outer circumferential portion. Accordingly, when the cushion material 14 is compressed due to the expansion of the battery cells at the time of charging, contact with members present on the side of the second elastic member 14b in a width direction D1 is restrained, as a result of which damage to the battery module 10 is restrained.

The number of the wave-shaped plate springs W to be stacked is not limited to two, and may be two or more. The number of the wave-shaped plate springs W to be stacked is not particularly limited and may be, for example, two or more and six or less.

The first elastic member 14a and the third elastic member 14c preferably have a Poisson ratio of 0.3 or less. When the Poisson ratio of the first elastic member 14a and the third elastic member 14c is 0.3 or less, the first elastic member 14a and the third elastic member 14c are more likely to absorb a thickness change associated with the expansion and contraction of the battery cells 11a. Note that the Poisson ratio of the first elastic member 14a and the third elastic member 14c is zero or more, for example.

The thickness of the first elastic member 14a when the state of charge of the battery cell 11a is 100% is not particularly limited and may be 0.05 mm or more and 0.1 mm or less, for example.

The first elastic member 14a and the third elastic member 14c are, for example, foams with a porosity of 30% or more and 95% or less. Examples of materials that constitute the foams include, but are not limited to, polyurethane, silicone resin, ethylene propylene rubber, styrene resin, olefin resin, polyamide, and polyester.

The materials constituting the first elastic member 14a and the third elastic member 14c may be the same or different.

The second elastic member 14b preferably has a Young's modulus of 35 GPa or more. When the Young's modulus of the second elastic member 14b is 35 GPa or more, the second elastic member 14b is more likely to absorb the thickness change associated with the expansion and contraction of the battery cells 11a. The Young's modulus of the second elastic member 14b is 200 GPa or less, for example.

Examples of materials that constitute the second elastic member 14b may include, but are not limited to, metal such as stainless steel and carbon steel, resin such as epoxy resin, phenolic resin and nylon resin, and fiber reinforced plastic (FRP) such as carbon fiber reinforced plastic (CFRP) and glass fiber reinforced plastic (GFRP). Among these, FRP is preferable, considering the energy density of the battery module 10.

The thickness of the second elastic member 14b when the state of charge of the battery cell 11a is 100% is not particularly limited and may be 1.0 mm or more and 1.2 mm or less, for example.

### [Manufacturing Method of Battery Module]

Description is now given of the manufacturing method of the cushion material 14. First, the second elastic member 14b is formed by stacking the wave-shaped plate springs W inside the first elastic member 14a having the frame-shaped member F arranged on the outer circumferential portion (see FIG. 3). In this case, since the second elastic member 14b is positioned by the frame-shaped member F, positional deviation is less likely to occur, resulting in improvement in the ease of assembling the cushion material 14. Then, the third elastic member 14c is formed by foaming and molding resin inside the first elastic member 14a where the second elastic member 14b is formed. In this case, both end portions of the second elastic member 14b in the longitudinal direction (a front direction and a depth direction in FIG. 2) are in contact with the frame-shaped member F. Therefore, when the resin used for foam molding is injected into the first elastic member 14a, the resin is restrained from entering into the second elastic member 14b. In this case, the second elastic member 14b is lightly pressed in with respect to the frame-shaped member F, for example.

In the case of foaming and molding resin inside a mold, in which the second elastic member 14b is arranged, without using the first elastic member 14a, the resin used for foaming and molding may enter into the second elastic member 14b from both longitudinal end portions of the second elastic member 14b when the resin is injected into the mold.

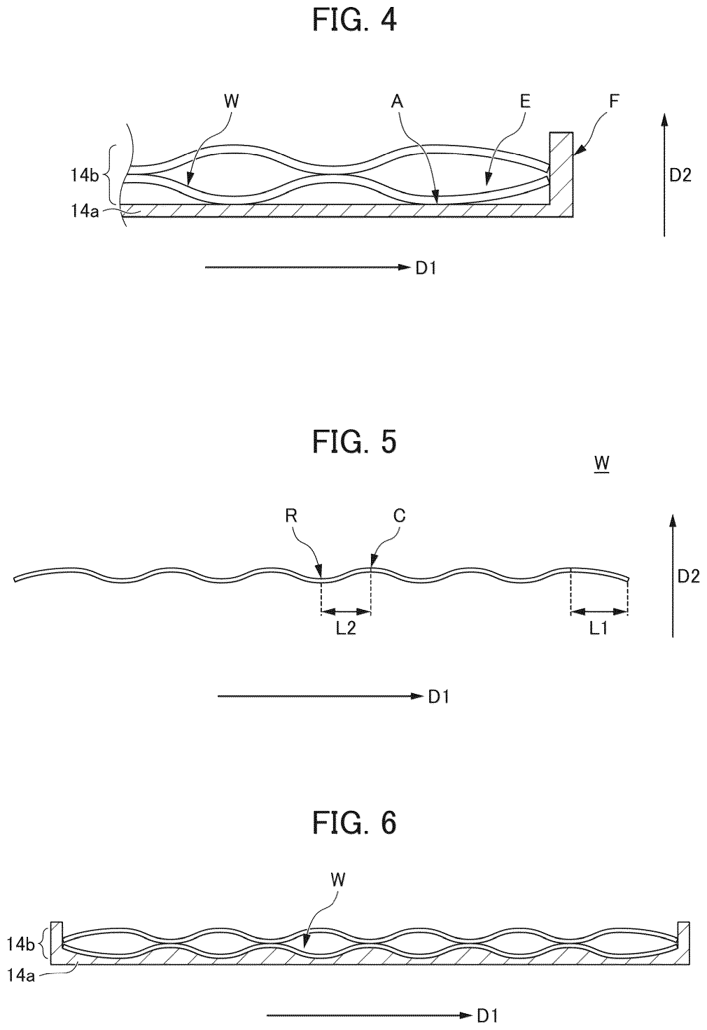

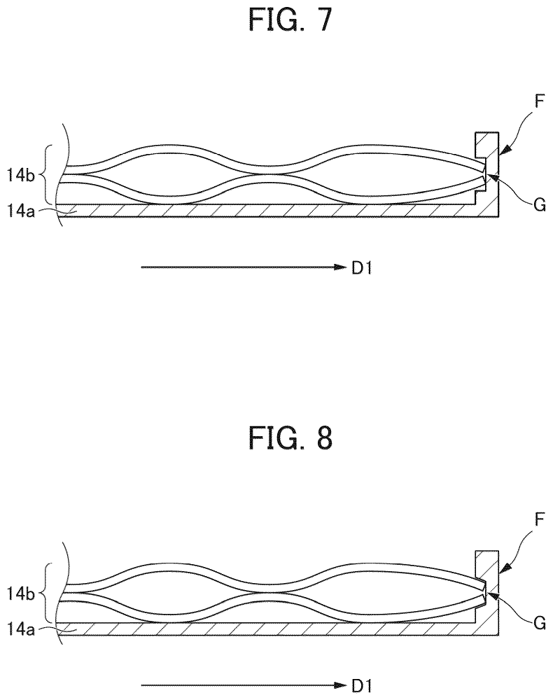

Here, the second elastic member 14b is formed so that a plurality of contact regions A where the second elastic member 14b is in contact with the bottom surface of the first elastic member 14a is present in the width direction D1. The wave-shaped plate spring W that is in contact with the bottom surface of the first elastic member 14a through the contact regions A has extension portions E extending outward in the width direction D1 from the contact regions A present at both the outermost portions in the width direction D1 (see FIG. 4). In this case, as each of the extension portions E increases in distance in the width direction D1 from the corresponding contact region A present on the outermost portion in the width direction D1, a distance in a thickness direction D2 from the bottom surface of the first elastic member 4a increases. Therefore, when the resin used for foaming and molding is injected into the first elastic member 14a, the resin is restrained from entering into the second elastic member 14b. At this time, the wave-shaped plate spring W, which is not in contact with the bottom surface of the first elastic member 14a through the contact regions A, has extension portions corresponding to the extension portions E included in the wave-shaped plate spring W that is in contact through the contact regions A.

The wave-shaped plate spring W that is in contact with the bottom surface of the first elastic member 14a through the contact regions A may have an extension portion E extending outward in the width direction D1 from the contact region A that is present at one outermost portion in the width direction D1.

As shown in FIG. 5, one of the wave-shaped plate springs W constituting the second elastic member 14b has recessed portions R and protruding portions C, which are alternately and continuously arranged, and extends in a depth direction in FIG. 5. In this case, the other adjacent wave-shaped plate spring W has recessed portions R and protruding portions C that face and are in contact with those in the one wave-shaped plate spring W. The recessed portions R and the protruding portions C are each protrude downward and upward in the thickness direction D2. In this case, the wave-shaped plate springs W have a length L1 in the width direction D that is larger than a length L2 in the width direction D, the length L1 extending between a top face of the protruding portion C (or a bottom face of the recessed portion R) adjacent to an end portion in the width direction D1 and the end portion in the width direction D, the length L2 extending between the bottom face of a recessed portion R and the top face of a protruding portion C that are adjacent to each other. Therefore, when the resin used for foaming and molding is injected into the first elastic member 14a, the resin is restrained from entering into the second elastic member 14b. At this time, the ratio of L1 to L2 is not particularly limited, and may be 1 or more and 2 or less, for example. The value of L1 is also not particularly limited, and may be 5 mm or more and 20 mm or less, for example.

Note that the bottom surface of the first elastic member 14a may have a wave-shaped cross section that corresponds to wave-shaped cross sections of the protruding portions C and the recessed portions R of the wave-shaped plate spring W that is in contact with the bottom surface of the first elastic member 14a (see FIG. 6). In other words, substantially the entire region of the bottom surface of the first elastic member 14a may be in contact with substantially the entire region of the protruding portions C and the recessed portions R of the wave-shaped plate spring W that is in contact with the bottom surface of the first elastic member 14a. In this case, since the second elastic member 14b is positioned by the bottom surface of the first elastic member 14a, positional deviation is less likely to occur, resulting in improvement in the ease of assembling the cushion material 14.

The frame-shaped member F may have a groove-shaped portion G in regions facing the end portions of the second elastic member 14b in the width direction D1. In this case, since the second elastic member 14b is positioned by the groove-shaped portion G, positional deviation is less likely to occur, resulting in improvement in the ease of assembling the cushion material 14. In addition, when the second elastic member 14b is lightly pressed in with respect to the frame-shaped member F, the second elastic member 14b is less likely to deflect, as a result of which dimensional accuracy of the third elastic member 14c is improved. Here, the depth of the groove-shaped portion G, that is, the length of the groove-shaped portion G in the width direction D1, is not specifically limited, and may be 0.5 mm or more and 2 mm or less, for example.

Here, the groove-shaped portion G preferably has both side surfaces shaped into a curved surface corresponding to the end portion of the second elastic member 14b in the width direction D1 (see FIG. 8). This improves the sealing performance of the cushion material 14. The shape of both the side surfaces of the groove-shaped portion G is not limited to the curved surface and may be, for example, an inclined surface as long as both the side surfaces correspond to the end portion of the second elastic member 14b in the width direction D1.

In addition, when the wave-shaped plate springs W are stacked inside the first elastic member 14a, some of the recessed portions R and the protruding portions C of the adjacent wave-shaped plate springs W that face each other and are in contact with each other may be bonded using an elastic adhesive, for example.

Publicly known methods may be used to manufacture the battery module 10 using the cushion material 14.

### [Battery Cell]

Examples of the battery cells 11a may include, but are not limited to, solid-state battery cells such as all-solid-state lithium metal battery cells, and electrolyte battery cells such as lithium metal battery cells. Among these, the solid-state battery cells are preferable.

The following describes the case where the battery cells 11a are all-solid-state lithium metal battery cells.

The all-solid-state lithium metal battery cell is formed by sequentially stacking, for example, a positive electrode current collector, a positive electrode mixture layer, a solid-state electrolyte layer, a lithium metal layer, and a negative electrode current collector.

Examples of the positive electrode current collector may include, but are not limited to, aluminum foil.

The positive electrode mixture layer contains a positive-electrode active material and may further contain solid-state electrolyte, a conductive assistant, a binding agent, or the like.

The positive active material is not particularly limited as long as lithium ions can be stored and released, though examples of the positive active material may include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

The solid-state electrolyte that constitutes the solid-state electrolyte layer is not particularly limited as long as lithium ions can be conducted, though examples of solid-state electrolyte may include oxide-based electrolytes and sulfide-based electrolytes.

Examples of the negative electrode current collector may include, but are not limited to, copper foil.

Although the embodiment of the present invention has been described in the foregoing, the present invention is not limited to the embodiment disclosed and the embodiment may be changed as appropriate within the scope of the present invention.

### EXPLANATION OF REFERENCE NUMERALS

10 battery module
11 battery cell stack
11a battery cell
12 end plate
13 bind bar
14 cushion material
14a first elastic member
14b second elastic member
14C third elastic member
A contact region
E extension portion
F frame-shaped member
G groove-shaped portion
W wave-shaped plate spring
R recessed portion
C protruding portion

What is claimed is:

1. A manufacturing method of a battery module, the battery module including a battery cell stack including a stack of a plurality of battery cells, a pair of plate-shaped members provided at both ends of the battery cell stack in a stacking direction, and a cushion material arranged between the plurality of battery cells and/or between the battery cell stack and the plate-shaped members,
the cushion material including a first elastic member having a frame-shaped member arranged on an outer circumferential portion, a second elastic member arranged inside the first elastic member, and a third elastic member arranged on both sides of the battery cell stack in the stacking direction of the battery cell stack,
the second elastic member having wave-shaped plate springs stacked in the stacking direction of the battery cell stack, the manufacturing method comprising:
a step of forming the second elastic member by stacking the wave-shaped plate springs inside the first elastic member; and
a step of forming the third elastic member by foaming and molding resin inside the first elastic member where the second elastic member is formed, wherein
when the third elastic member is formed, longitudinal end portions of the second elastic member are in contact with the frame-shaped member.

2. The manufacturing method of a battery module according to claim 1, wherein the second elastic member is formed so that a plurality of contact regions where the second elastic member is in contact with a bottom surface of the first elastic member are present in a width direction,
the wave-shaped plate spring that is in contact through the contact regions has an extension portion extending outward in the width direction from the contact region present in an outermost portion in the width direction, and
as the extension portion increases in distance in the width direction from the contact region that is present on the outermost portion in the width direction, a distance in a thickness direction from the bottom surface of the first elastic member increases.

3. The manufacturing method of a battery module according to claim 1, wherein the bottom surface of the first elastic member has a wave-shaped cross section that corresponds to a wave-shaped cross section of the plate spring that is in contact with the bottom surface of the first elastic member.

4. The manufacturing method of a battery module according to claim 1, wherein the frame-shaped member has a groove-shaped portion in a region facing an end portion of the second elastic member in the width direction.

5. The manufacturing method of a battery module according to claim 4, wherein the groove-shaped portion has both side surfaces that are shaped so as to correspond to the end portion of the second elastic member in the width direction.

6. The manufacturing method of a battery module according to claim 1, wherein the battery cells are solid-state battery cells.
